(19) United States
(12) Patent Application Publication
(10) Pub. No.: US 2004/0216643 A1
(43) Pub. Date: Nov. 4, 2004

(54) Coloring agents which are soluble in aqueous media and method for the production thereof

(76) Inventors: Michel Boudin, Ambourville (FR); Yannick Cuvilly, Barentin (FR); Frederic Fleurry, Toronto (CA)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/481,575

(22) PCT Filed: Jun. 21, 2002
(86) PCT No.: PCT/FR02/02163

(30) Foreign Application Priority Data
Jun. 22, 2001 (FR) 01/08575

(51) Int. Cl. C08K 5/00

(52) U.S. Cl. 106/499

(57) ABSTRACT

The invention relates to the production of coloring agents which are soluble in water and in aqueous vehicles. The soluble coloring agents are, in particular, organic and are especially used in the food industry. The inventive coloring agents are characterized in that they are present in a solid form mixed with an effervescent agent in a binder which is essentially composed of polyethylene glycol wherein they are previously diluted at a temperature which is higher than the fusion temperature of said binder. Preferably, the method for the production of said coloring agents involves a dry mixture of two constituents introduced in a powdery form prior to the heating of said mixture, resulting in the fusion of the binder.

The present invention is related to the industry of colorants, i.e. coloring matters and dyestuffs. It concerns the manufacture of coloring matters that are soluble in aqueous media, such as those based on dye compounds of organic nature, which are designed for being marketed in solid form to be used in various industries for the coloration of aqueous vehicles.

The dyes considered are used in particular in the food industry, and they are useful there for coloring food. Industrially distributed food such as beverages stand but for one example, since there are also numerous types of solid food that are currently colored in a similar way. To a lesser extent, but however important, these coloring matters are also used in the pharmaceutical and cosmetic industries. Anyway, it is not intended here to restrict the invention to a specific application area, although one should pay attention to the fact that, according to preferred modes of implementation, the invention shows the advantage of leading to non toxic products, that are compatible with all sanitary stipulations required for products that are intended to be ingested by a human body. Same demands exist also for animals, especially for farm animals, so that the invention satisfies the same requests in the field of coloring matters for animal feeding, for instance for marking with different colors various food compounds.

To meet the requirements of this type of industries, there exist numerous so-called synthetic organic dyes, which belong to various chemical families. Although they show the advantage of being cheaper than natural colors and,they exhibit a much higher coloring power that remains constant between various manufacturing batches, they are not free from disadvantages. In particular, their low solubility leads to offering them in powder form, with a micronic grain size that is generally produced directly during the dye compound synthesis, either in achieving the last stage in a fluidized bed reactor or in a further step of micronization of the final filtration cake. In other words, not considering their high coloring power, these coloring matters, based on organic molecules, would be used in the same way as mineral coloring matters, made of micronized crystalline pigments.

The use of such coloring matters raises serious problems, concerning their packing and transportation as well as on the application site. Powders are volatile and highly soiling. Whichever precautions can be taken in their handling, particularly in mixers and dissolving tanks, they generate dust which infiltrates everywhere, sticks to walls and spoils equipments with intense coloration. Amongst other consequences, there is also the impossibility of complying with the more and more severe demands in the fields of hygiene and safety, in addition to the need of frequent and difficult cleanings and to the wearing of dust masks by the operators.

As a solution to the resulting problems in industry, particularly the above mentioned ones, the present invention proposes that the coloring matters, particularly those intended for the food industry, be presented in solid form in admixture with a binder essentially made of polyethylene glycol, wherein they are first diluted at a temperature higher than the melting point of the binder. Preferably, the mixture includes a further component that is able to develop an effervescent effect in the aqueous medium in which the dye will be added. That component, or effervescent agent, is in preferred practice a mixture of two compounds that are finely distributed, separately, in the final product, so that they are ready to react together, but only in the presence of water.

At the origin of the invention, it was noticed that polyethylene glycol in molten state is able to easily dissolve large amounts of the chemicals constituting organic coloring matters, and in addition, for an equal weight of dye compound, the solid compound containing them in intimate mixture with the binder, as it is obtained after cooling, has a better solubility or at least is more quickly soluble in water and aqueous media, compared to the original micronic powder.

According to the preferred application systems of the invention, the addition of an effervescent agent is adjusted in order to get the best ability of the final product, i.e. the mixture in solid state, to quickly dissolve in water, and its nature is selected to ensure its solubility in efficient proportions in the binder. Such an effervescent agent can advantageously be selected from combinations able to generate carbonic acid that are non toxic and acceptable in the food industry. A typical example for such a combination is a mixture in approximately stoechiometric proportions of citric acid and sodium carbonate, both these products being easy to dissolve in the binder with no effervescent reaction as long as the mixture is not in contact with water.

Another object of the invention is a method for manufacturing coloring matters or dyestuffs, particularly such coloring matters intended for the food,industry, essentially comprising diluting an organic dye compound in powder form in a molten binder, the latter being essentially made of polyethylene glycol advantageously admixed with an effervescent agent, and cooling the resulting mixture in order to obtain a coloring matter in solid form in which the coloring matter is intimately mixed with the binder.

In its preferred embodiments, the invention shows various secondary characteristics, which can be used individually or in technically operational combinations, to obtain a coloring matter such as those that also form an object of the invention, i.e. a coloring product in solid form that does not generate dirty dusts and is soluble in aqueous vehicles.

In particular, as regards the manufacturing process, the initial coloring matter is preferably a powder of micronic grain size, the polyethylene glycol is also preferably in powder form, and the two powder components are advantageously mixed in the dry state before being heated at a temperature high enough to ensure melting of the binder.

As far as the preferred components of the products are concerned, it should be noted that the polyethylene glycol is a polyolefin class polymer which, according to the invention, is used in a quality corresponding to a relatively low polymerisation rate, so that it is not only highly soluble but it is further fusible at a temperature below 120° C. Practically, the preferred quality of polyethylene glycol or homologous or equivalent compounds are those with which melting can be performed at temperatures between 40 and 80° C. Should it be only for economical reasons, it is always worth it that heating at a gentle temperature be sufficient, and in addition one has to avoid effects that could damage the coloring matter. But further it is desirable to obtain a product in solid form at ambient temperature that can also stand to temperature variations in user's plants.

On the other hand, although it can be contemplated that the mixture of a micronized powder of dye compound with the binder in the final solid product be sufficiently intimate to avoid any production of spoiling micronic dust, it is preferable to ensure complete true dissolution of the dye compound during its dilution in the binder. It should however be understood that the invention includes cases where dissolution is only apparent, each micronic sized particle being individually embedded, in the binder. In a similar way it is usual in industrial practice to give the name of dyes to mineral pigments when, because of their ultra, small, grain size, their behaviour is such that their diluted form can be considered as a true solution. In connection therewith the invention provides for starting preferably with a powder dye of particle size low than 100 microns and advantageously between 10 and 50 microns.

Similar fine grain size conditions are recommended when it is intended to directly introduce the compound into the separately already molten binder which is then a viscous liquid. In the case when, according to preferred embodiments of the invention, the mixture is first prepared in the dry state, the introduction of polyethylene glycol in divided form is preferably performed using particle sizes of the order of a millimeter, since economical reasons (mainly considering the costs for the starting matters) lead to prefer a particle size above 500 microns.

Similar conditions also preferably applied to the effervescent agent components completing the composition. In particular, the latter are preferably also in solid powder form and they are blended dry with polyethylene glycol, before or during its admixture with the dye compound.

The proportions of the components can be highly variable, depending in particular upon their respective physico-chemical properties. They can also vary according to the dimensions desired for the final product. The latter will also be highly variable according to the particular application the product is designed for. For example, for a product in a solid and highly divided form, namely for making a pourable product, made of grains or similar elements and delivered in bulk, it is advantageous to prefer a composition with a lower polyethylene glycol content than for a product finally in brick or lump form requesting shaping by moulding or possibly by extrusion.

One of the high advantages of the invention relates to the wide range of dimensions which can be achieved in economical conditions to meet each customer's requirements. Another advantage dwells in the safe and easily attained reproducibility of colors and shades, and the wide range of shades. As a whole, for each workshop using a coloring matter designed according to the invention, the correct dosage of coloring matter is easy to secure, since the concentration is constant in the delivered product and the latter can possibly be supplied in unidose amount corresponding to any appropriate weight.

Moreover, the product obtained according to the invention can advantageously contain a mixture of various organic dye compounds, in order to obtain any color at will. It is thus obvious that in this case, the manufacturer has to ensure, in accordance with the invention, the appropriate composition, and to thus preserve the production of the requested shade for a given dosage. The user has no longer to fear consequences of mistakes or lacks of care in the weighing of each dose of the individual dye compound.

According to other advantageous characteristics, the invention product composition includes 10 to 80%, preferably 15 to 60% of polyethylene glycol (PEG) with respect to the total weight of the composition. The dye proportion is advantageously between 10 and 70%, preferably between 30 and 50%, with respect to the composition total weight. As far as the effervescent agent is concerned, in ternary mixtures, it is advantageously present at a level of 10 to 60%, preferably 15 to 50%, with respect to the composition total weight. In any case, whether the total composition include an effervescent agent or not, the best results seem to be obtained when the binary mixture with polyethylene glycol contains 0.5 to 1.5 part in weight of polyethylene glycol for one part of the initial coloring compound.

As regards the final product as it is presented in solid state, it must be noted that it can be under the shape of grains or granules in bulk, the dimensions of which are between 0.2 and 10 millimeters, thus roughly of the order of a millimeter. Such granules can be obtained by direct precipitation from the molten mixture of the components. One can also obtain dimensionally non isotropic elements, similar to vermicelli, cut out from a yarn having also a diameter of the orders of a millimeter, obtained by extrusion of the viscous paste of the molten mixture while it is being cooled down. Blocks can also be obtained by moulding in a great variety of moulds of various shapes and dimensions, from pellets to bricks. For correctly calculated dimensions in view of a particular application, each element or block can advantageously represent the dose of coloring matter for a given manufacturing batch of the aqueous vehicle in which it is to be dissolved.

The invention is illustrated by way of examples hereinafter, which examples provide a detailed description of particular embodiments of the process of the invention, in connection with the production of coloring matters for the food industry which meet specific compositions in accordance with the preferred characteristics of the coloring matters according to the invention. As a whole, all values mentioned are indicated in conformity with the international legislation on the one hand, and in amounts pertaining to the mass on another hand. Unless otherwise stated, the proportions of the components in the compositions described are given in percentage pertaining to the total mass of the mixture of these components.

### EXAMPLE I

According to the invention, an organic compound known as a synthetic dye is used, such as it is usually manufactured, in powder form of micronic grain size, by fluidization or micronization at the end of the industrial synthesis process.

In the present case, the starting product is 70% pure quinoleine yellow, in conformity with the European food dye standard E104. Its chemical formula reads as 2-(2-quinolyl) indan-1,3-dione sulphonate, in practice mainly sodium disulphonate.

The binder used is the commercial grade of polyethylene glycol (PEG), in the form of granules with an average grain size of the order of 500 microns.

In addition to the binder and the basic dye compound, the composition includes an effervescent agent. The latter is a previously prepared ready-to-use, agent composed of 0.64.5% citric acid and 35.5% sodium carbonate,both in crystalline form. These proportions are consistent with the stoechiometric balance for the effervescent reaction between the two constituents.

The composition is prepared by dry mixing 40% by weight of E104 with 25% by weight of PEG and 35% by weight of effervescent agent (total of its two components).

The powder mixture obtained is cautiously heated until it becomes uniformly liquid. This is carried out in a boiling water bath, i.e. at a temperature near 100° C. The melting temperature of the mixture is governed by the one of the PEG quality used, here 54° C., and in the absence of moisture, the effervescent agent is inert to it in solution.

The molten mixture is then cooled in order to obtain a precipitate of slightly pasty solid granules which are collected and maintained under gentle stirring until complete cooling down to the ambient temperature, in order to prevent granules from clustering together into blocks.

When, as a test, a few granules of the coloring product are dropped in a glass of water, obviously they dissolve at once, and when a gentle stirring with a spoon is carried out, the solution is readily complete, producing a colored but clear liquid. In comparison, when a pinch of the initial dye compound is dropped in another glass of water, its settling down onto the bottom of the glass cannot be avoided, and for dissolving it a strong and lengthy stirring is required.

### EXAMPLE II

Broadly the same procedure as in example I is applied, E104 being replaced by food dye E102, i.e. tartrazin yellow, the formula of which is phenyl-azo-pyrazole trisodium carboxylate. The industrial powder is 85% pure, its molecular weight is 534.4. Its color is orange and it gives a yellow color in solution.

The selected composition is 40% of E102, 27.5% of PEG and 32.5% of effervescent agent. All components are mixed together in the dry state, citric acid and sodium carbonate being added separately.

The mixture is heated up to a temperature of 70-80° C. and maintained at this temperature until a homogeneous liquid is obtained. As in the previous example, cooling leads to solid granules.

The granules are sieved with mesh dimension adapted to the desired grain size. In a particular example, sieving is carried out in two or three steps, between which too large particles are crushed, in order to finally obtain substantially isotropic granules having a diameter around 0.5 to 1.0 millimeter.

The product is weighed and delivered in bulk. It is particularly of interest for beverage manufacturers as it is easy to dissolve it in aqueous media using the already existing homogenisation equipment used in plants for classical dyes. It is worth noticing that the yellow shade of the original dye is not at all modified by the process of the invention.

### EXAMPLE III

It is performed as in the previous examples for a composition comprising 40% by weight of dye E102 or E104 for 35% by weight of PEG and 25% by weight of the total of the two components in the effervescent agent.

The production of granules is obtained without difficulty, while avoiding a pasty consistency which might lead to the formation of blocks that would have to be crushed. The granules obtained have a diameter smaller than 2 to 3 millimeters.

Same process is applied to ponceau red E124 (a compound in the category of naphthalene monoazo derivatives, with a purity of 85%), and also to a dye E131, the latter being a triarylmethane named patent blue (at a 85% purity).

In another case, concerning a dye E151 for a strongly effervescent beverage, the composition used comprises 50 parts by weight of effervescent agent for 40 parts by weight of PEG and 10 parts by weight of the dye The resulting coloring powder is of course weaker, but the final color afforded by the product once dissolved is unaltered inasmuch as the dilution rate of the original dye is the same.

As a whole, whichever the selected organic dye may be, the process used, wherein the product is granulated during cooling of the molten mixture, leads to granules with a size of the order of a millimeter, advantageously varying from 0.2 to 10 mm in diameter.

### EXAMPLE IV

To 40% by weight of PEG are added 25% by weight of effervescent agent (total weight of its two components) then 35% by weight of dye E104.

The total products are carefully mixed in dry conditions, then slowly heated up to a temperature of about 70° C. A liquid is obtained which is allowed to cool down to a temperature of 45-50° C. so that it becomes viscous enough to show a pasty state allowing its shaping by extrusion.

It is thus during the cooling towards a solid state that the mixture is extruded through a 2 mm diameter spinneret. At the outlet, the continuous filament is cut into elements named vermicelli having a 0.5 to 1.0 mm length.

In a similar example the same procedure is applied using the dye E102 but for producing elements of about 4 mm diameter, from a mixture containing 40% of dye powder, 40% of PEG and 20% of effervescent agent.

### EXAMPLE V

The dye E124 (ponceau red) is used at a dosage of 35%, with 40% of PEG and 25% of effervescent agent.

In the course of the cooling operation after melting, the still pasty mixture is shaped by extrusion through a spinneret producing a continuous filament with a diameter of about 2 mm which is immediately cut into elements having a length of approximately 1 cm.

By varying this length, for instance to values from 0.5 to 20 mm, it is possible to control the amount of initial dye represented by each element.

### EXAMPLE VI

To 45% by weight of molten PEG are added 35% by weight of food dye E132 (indigotin blue) and 20% by weight of effervescent agent.

The homogeneous liquid obtained is cooled until it shows a pasty state, at a temperature about 40 to 50° C., and it is introduced in moulds out of which it is taken out after complete cooling under the shape of monodose elements.

With moulds leading to disc-shaped pellets with a diameter of 4 cm and a thickness of 5 mm, each pellet weight is 10 grs, which represents the coloring power of 3.5 grs of the initial dye.

### EXAMPLE VII

The same procedure as in the previous examples is performed, except that the part of the dye in the composition comprises 30% by weight of dye E132 (indigotin blue) and 70% of dye E102 (tartrazin yellow).

A coloring matter affording a green shade is thereby obtained. It is interesting to note that the two initial dyes are intimately and uniformly distributed in each of the solid elements, granules or vermicelli, or in each pellet or piece of other shape as moulded.

### EXAMPLE VIII

The same procedure as above is used aiming at the manufacture of a coloring matter designed for use by a manufacturer of pet food under the shape of dry small pieces (“croquettes”).

The initial dye is E171, which is a micronized powder of titanium dioxide. It is diluted in a mixture of PEG in the molten state and a mixture of the effervescent agent, at a temperature between 50 and 70° C. The agglomerated elements obtained during cooling have a size between 2 and 5 mm.

At the user's, the product dosage in the dry food mixture can be adjusted to reach a concentration of about 10% of the dye E171 proper. As a comparison, if that dye is used directly without having been submitted to the treatment according the invention, it is fast impossible to obtain a concentration higher than 0.5% by weight. One can note here an advantage that comes in addition to avoiding dust problems during the handling ensuring food coloration by a dispersion of the mineral dye that, in the application, is equivalent to a dissolution.

As an alternative to this example, the mineral dye E171 made of titanium dioxyde is replaced by tartrazin dye E102, such as is used in a known manner in such kind of dry food in view of a final concentration of 0.1% by weight.

In another alternative, both dyes are combined in a sole coloring matter according to the invention, by introducing them simultaneously for dissolutieon or pseudo dissolution in molten polyethylene glycol in admixture with the components of the effervescent mixture. On the occasion, it is clear that the mixture of dyes and their respective dosages are safely ensured at the stage of manufacturing the product according to the invention, and that the customer has no longer to handle spoiling dusts. He is in addition sure he will obtain the desired color under full reproducibility.

1. Cancel

2. Cancel

3. Cancel

4. Cancel

5. Cancel

6. Cancel

7. Cancel

8. Cancel

9. Cancel

10. Cancel

11. Cancel

12. Cancel

13. Coloring matters of organic nature soluble in aqueous media, presented as a product in a solid state containing a dye compound in admixture with a binder mainly made of polyethylene glycol in which it is dissolved beforehand at a temperature higher than the melting temperature of said binder, and additionally containing an effervescent agent also dissolved in the dry state in said binder.

14. Coloring matters according to claim 1, wherein the effervescent agent is present in the proportion of 10 to 50% with respect to the total weight of the product.

15. Coloring matters according to claim 2, wherein the effervescent agent is present in the proportion of 15 to 30% with respect to the total weight of the product.

16. Coloring matters according to claim 1, wherein the effervescent agent is a mixture of two compounds that react together only in the presence of water.

17. Coloring matters according to claim 1, wherein the effervescent agent is a mixture of citric acid and of a carbonate.

18. Coloring matters according to claim 1, characterized by a composition comprising from 10 to 80% of polyethylene glycol with respect to the total weight of the composition.

19. Coloring matters according to claim 6, wherein said composition comprises from 20 to 60% of polyethylene glycol with respect to the total weight of the composition.

20. Coloring matters according to claim 1, characterized by a composition comprising from 10 to 70% of the dye compound with respect to the total weight of the composition.

21. Coloring matters according to claim 8, wherein said composition comprises from 30 to 50% of the dye compound with respect to the total weight of the composition.

22. Coloring matters of organic nature for the food industry, soluble in aqueous media, presented as a product in a solid state containing a dye compound in admixture with a polyethylene glycol binder in which it is dissolved beforehand at a temperature higher than the melting temperature of said binder, and additionally containing an effervescent agent also dissolved in the dry state in said binder, in a proportion of 10 to 50% with respect to the total weight of the product, the composition of said product comprising from 10 to 80% of polyethylene glycol binder and from 10 to 70 of dye compound with respect to the total weight of the composition.

23. Coloring matters according to claim 10, wherein the effervescent agent is a mixture of citric acid and of a carbonate.

24. Coloring matters of organic nature for the food industry, soluble in aqueous media, presented as a product in a solid state containing a dye compound in admixture with a polyethylene glycol binder in which it is dissolved beforehand at a temperature higher than the melting temperature of said binder, and additionally containing an effervescent agent also dissolved in the dry state in said binder, which is a mixture of citric acid and of a carbonate, the composition of said product comprising from 20 to 60% of polyethylene glycol binder, from 15 to 30% of effervescent agent and from 30 to 50% of the dye compound, with respect to the total weight of the composition.

25. A method for producing coloring products, useful as coloring matters for the food industry, comprising dissolving a powder of organic dye compound and an effervescent agent in a molten binder mainly made of polyethylene glycol, and cooling the resulting mixture in the dry state to obtain a coloring matter in solid state, in which the dye compound and the effervescent agent are intimately mixed with the binder.

26. A method according to claim 13, wherein the starting dye compound is initially under the form of a powder of micronic grain size.

27. A method according to claim 14, wherein the binder is itself used in powder form and admixed in the dry state with the dye compound and the effervescent agent before heating the mixture at a temperature high enough to ensure melting of the binder.

28. A method according to claim 15, wherein said temperature is from 40 to 80° C.

29. A method according to claim 15, wherein said effervescent agent is a mixture of two compounds.

30. A method according to claim 17 wherein, the effervescent agent is a mixture of citric acid and of a carbonate.

31. A method according to claim 17, wherein said two compounds are introduced separately, in the dry state, in the mixture of the dye compound and the binder before melting.

32. A method according to claim 15, wherein the molten mixture is shaped by moulding during its cooling.

33. A method according to claim 20, wherein the molten mixture is shaped by extrusion during its cooling.

34. A method according to claim 15, wherein the product is precipitated in the form of granules having dimensions of the order of a millimeter, directly from the molten mixture during cooling.

35. A method according to claim 15, wherein the mixture conforms to a composition comprising from 20 to 60% of polyethylene glycol binder, from 15 to 30% effervescent agent, and from 30 to 50% of the dye compound, with respect to the total weight of the composition.

36. A method for producing coloring products, useful as coloring matters for the food industry, comprising dissolving a powder of organic dye compound and an effervescent agent in a molten binder mainly made of polyethylene glycol, and cooling the resulting mixture in the dry state to obtain a coloring matter in solid state, in which the dye compound and the effervescent agent are intimately mixed with the binder, wherein the starting dye compound is initially under the form of a powder of micronic grain size and the binder is itself used in powder form and admixed in the dry state with the dye compound and the effervescent agent before heating the mixture at a temperature from 40 to 80° C., and wherein said effervescent agent is a mixture of two compounds that are introduced separately, in the dry state, in the mixture of the dye compound and the binder before melting.

37. A method for producing coloring products, useful as coloring matters for the food industry, comprising dissolving a powder of organic dye compound and an effervescent agent in a molten binder mainly made of polyethylene glycol, and cooling the resulting mixture in the dry state to obtain a coloring matter in solid state, in which the dye compound and the effervescent agent are intimately mixed with the binder, wherein the starting dye compound is initially under the form of a powder of micronic grain size and the binder is itself used in powder form and admixed in the dry state with the dye compound and the effervescent agent before heating the mixture at a temperature from 40 to 80° C., wherein said effervescent agent is a mixture of citric acid and of a carbonate that are introduced separately, in the dry state, in the mixture of the dye compound and the binder before melting, and wherein the mixture conforms to a composition comprising from 20 to 60% of polyethylene glycol binder, from 15 to 30% effervescent agent, and from 30 to 50% of the dye compound, with respect to the total weight of the composition.
